(19) United States
(12) Patent Application Publication
(10) Pub. No.: US 2020/0324481 A1
(43) Pub. Date: Oct. 15, 2020

(54) PRINTING CAPABILITY PROTECTION VIA CONSUMABLES

(71) Applicant: Hewlett-Packard Development Company, L.P., Spring, TX (US)

(72) Inventors: Craig Peter SAYERS, Palo Alto, CA (US); Helen BALINSKY, Bristol (GB)

(73) Assignee: Hewlett-Packard Development Company, L.P., Spring, TX (US)

(21) Appl. No.: 16/759,230

(22) PCT Filed: Oct. 31, 2017
(86) PCT No.: PCT/US2017/059302

§ 371 Date: Apr. 24, 2020

(51) Int. Cl. B29C 64/386; B33Y 50/00; G05B 19/4099

(52) U.S. Cl. CPC B29C 64/386; B33Y 50/00; G05B 2219/49023; G05B 2219/35134; G05B 19/4099

(57) ABSTRACT

A system for protecting a printing capability may include sprinting consumable, and a data element associated with the printing consumable, the data element defining an assigned association between the printing consumable and a printing capability. Also, a method of protecting a printing capability via consumables may include assigning an association between a printing consumable and a printing capability, the association protecting the printing capability based on availability of the printing consumable, determining whether the printing consumable is installed in a 3D printing device to allow for the execution of the printing capability in forming a 3D object, and in response to a determination that the printing consumable is installed in the 3D printing device to allow for the execution of the printing capability, permitting the printing of the 3D object using the printing capability and consuming of the printing consumable.

### BACKGROUND

In various manufacturing sectors, individuals and groups develop a myriad of manufacturing techniques. These manufacturing techniques may be product-specific techniques that are used to produce a specific product. These product-specific manufacturing techniques differentiate the manufacture's genuine quality from another manufacture's products. Other manufactures who do not apply the developed manufacturing techniques may produce lower-quality products since these manufacturing techniques may be proprietary and kept as a trade secret by the manufacturer.

Three-dimensional (3D) printing may be any process that uses additive manufacturing and other techniques to form a 3D object. 3D printing may cause some manufacturing techniques, including those that are proprietary trade secrets, to be captured as digital instructions and shared through a network to a 3D printing device to form a 3D object of as high quality as those 3D objects developed by the proprietary manufacturer.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for protecting a three-dimensional (3D) printing capability, according to an example of the principles described herein.

FIG. 2 is a block diagram of a system for protecting a three-dimensional (3D) printing capability, according to another example of the principles described herein.

FIG. 3 is a flowchart showing a method of protecting a printing capability via consumables, according to an example of the principles described herein.

FIG. 4 is a flowchart showing a method of protecting a printing capability via consumables, according to another example of the principles described herein.

FIG. 5 is a flowchart showing a method of protecting a printing capability via consumables, according to still another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In situations where manufacturing techniques, including those that include proprietary trade secrets or patented technologies, are captured as digital 3D manufacturing instructions, proprietary rights may be lost through allowing any individual or manufacturer to obtain those digital 3D manufacturing instructions and use them in connection with a 3D printing device to obtain a 3D object embodying the proprietary trade secrets. Not securing these proprietary manufacturing techniques and processes can result in competitors or other interested parties legally or illegally manufacturing products that are as high a quality as the original manufacturer or manufacturing products that can compete with the manufacturer's products. In other words, a consumer may not be able to differentiate between products that are manufactured using the proprietary manufacturing techniques and trade secrets. This, in turn, may result in the manufacturer loosing significant market share and business revenue due to having to share a market in which they previously enjoyed the benefits of an exclusive proprietary right to the manufacturing technique.

Further, some businesses have moved to 3D printing to produce products embodying their respective manufacturing techniques and processes. In these scenarios, the business may request a 3D manufacturing company to produce the products on behalf of the business, but may not wish the 3D manufacturing company to have access to proprietary manufacturing techniques and processes. Although additional payment mechanisms and legally binding agreements such as non-disclosure agreements between the business and the 3D manufacturing company may help to reduce the possibility and liability of loss of any proprietary rights to the 3D models, these types of business and legal mechanisms may be expensive to produce through utilization of legal counsel, and may not ultimately stop willful infringement or violation of such agreements.

Examples described herein provide a method of protecting a printing capability via consumables may include assigning an association between a printing consumable and a printing capability, the association protecting the printing capability based on availability of the printing consumable, determining whether the printing consumable is installed in a 3D printing device to allow for the execution of the printing capability in forming a 3D object, and in response to a determination that the printing consumable is installed in the 3D printing device to allow for the execution of the printing capability, permitting the printing of the 3D object using the printing capability and consuming of the printing consumable.

The method may include regulating provisioning of the printing consumable based on a determination as to whether the printing capability is used to print the 3D object. In response to a determination that the printing capability is used to print the 3D object, the corresponding printing consumable may be provided to an operator of the 3D printing device. In response to a determination that the printing capability is not used to print the 3D object, access to the printing consumable may be restricted.

Assigning the association between the printing consumable and the printing capability may include identifying the protectable printing capability for manufacturing of the 3D object, identifying the printing consumable associated with the protectable printing capability, and storing data relating to the association between the printing consumable and the protectable printing capability.

The method may include electronically sending permission to use the printing capability to the 3D printing device. Further, the method may include electronically sending a model defining the 3D object to the 3D printing device where the model includes instructions to use the printing capability. The method may also include determining whether the printing consumable authorizes the use of the printing capability used to manufacture the 3D object, and in response to a determination that the printing consumable authorizes the use of the printing capability, printing of the 3D object using the printing consumable may be allowed. In response to a determination that the printing consumable does not authorize the use of the printing capability, printing of the 3D object using the printing consumable may be restricted.

Examples described herein may also provide a computer program product for protecting a three-dimensional (3D) printing capability, which is a part of 3D printer functionality. In some examples, the printing capability may be a functionality used to manufacture a 3D design. The computer program product may include a computer readable storage medium comprising computer usable program code embodied therewith. The computer usable program code may, when executed by a processor, identify the presence of a printing consumable in a 3D printing device, and identify a data element associated with the printing consumable. The data element defines an assigned association between the printing consumable and a printing capability. In some examples, this data element in combination with printing consumable may act as an authorization code for the printing capability to be used during the manufacturing of the 3D object. The method may also include printing a 3D object based on a model defining the 3D object and the printing capability, and consuming the printing consumable.

The computer program product may also include computer usable program code to, when executed by the processor, determine whether the printing consumable authorizes the use of the printing capability, and in response to a determination that the printing consumable authorizes the use of the printing capability, print the 3D object consuming the printing consumable. In response to a determination that the printing consumable does not authorize the use of the printing capability, printing of the 3D object using the printing consumable may be restricted.

The computer program product may also include the computer usable program code to, when executed by the processor, assign an association between a printing consumable and a printing capability. The association protects the printing capability based on availability of the printing consumable. The computer program product may also include the computer usable program code to, when executed by the processor, determine whether the printing consumable is installed in a 3D printing device to allow for the execution of the printing capability in forming a 3D object, and in response to a determination that the printing consumable is installed in the 3D printing device to allow for the execution of the printing capability, printing the 3D object using the printing capability and consuming the printing consumable.

Examples described herein may also provide a system for protecting a printing capability. The system may include a printing consumable, and a data element associated with the printing consumable, the data element defining an assigned association between the printing consumable and a printing capability. The data element may include a decryption key embedded within the printing consumable, the decryption key decrypting data providing access to the printing capability. The data element may include a computing device embedded in the printing consumable. The computing device may include a processor and a data storage device. The processor executes the printing capability based on data stored in the data storage device. The data element may include an identifier marked on the printing consumable. The identifier may be verifiable by a 3D printing device, and enables the printing capability programmed in firmware of a 3D printing device. The printing capability may include a number of 3D printing techniques executable by a 3D printing device. A 3D printing device may include a number of individually addressable, authorizable, and/or sellable capabilities, which can be used in any combination.

As used in the present specification and in the appended claims, the terms “capability” or “printing capability” are meant to be understood broadly as any function executable by a printing device, technique executable by a printing device, property of materials utilized by the printing device, or features printable by the printing device. In one example, the printing device is a three-dimensional (3D) printing device. In the examples described herein, the capability may be any series of functions, techniques, properties of materials, or features used in the formation of a 3D object, or combinations thereof. The series of functions or techniques may include, for example, material deposition techniques, color printing techniques, black and white printing techniques, adhesive deposition techniques, heat application techniques, material polishing techniques, material removal techniques, surface finishing techniques, 3D scanning techniques, other functions and techniques, or combinations thereof. The properties of materials may include visual properties of the materials such as translucency, transparency, color, and physical properties of the materials including, for example, elasticity, hardness, strength, density, thermal conductivity, electrical conductivity, absorption, melting point, opacity, permeability, plasticity, resistivity, solubility, reflectivity, specific heat, atomic mass, atomic weight, corrosion resistance, pH, reactivity, surface tension, capacitance, dielectric constant, piezoelectric constant, hysteresis, other visual and physical properties, or combinations thereof.

As used in the present specification and in the appended claims, the term “printing consumable” is meant to be understood broadly as any material or other consumable used to form an object from a 3D model of the object including, for example, build materials, adhesives, and materials used by finishing stations providing a number of finishing processes such as polishing compounds, replaceable heating elements, air filters. In one example, a number of printing consumables may be integrated into a 3D printing device, or may be included in a separate, post-printing device or system.

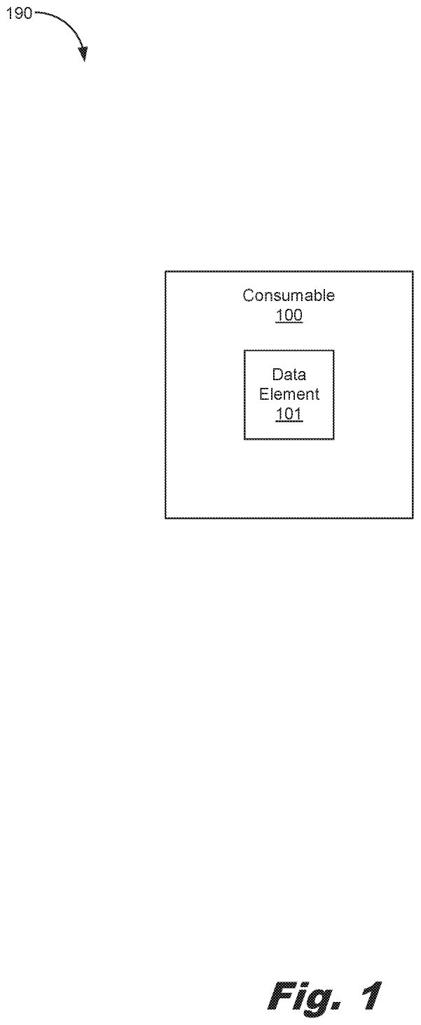

Turning now to the figures, FIG. 1 is a block diagram of a system (190) for protecting a printing capability, according to an example of the principles described herein. The system (190) may include a printing consumable. The printing consumable (100) may be any material or operation used to form an object from a 3D model of the object. For example, in a 3D printing operation, a 3D printing device may use, for example, build materials, and adhesives in forming a 3D object. Further, the 3D printing device may include a number of associated stations such as finishing stations that assist in forming the 3D object. These associated stations may include 3D scanning stations, polishing stations, heating stations, curing stations, or other finishing stations coupled to the 3D printing device. These associated stations may be integrated into the 3D printing device or may be separate devices. Thus, the printing consumable (100) may be any material or device used to form the 3D object.

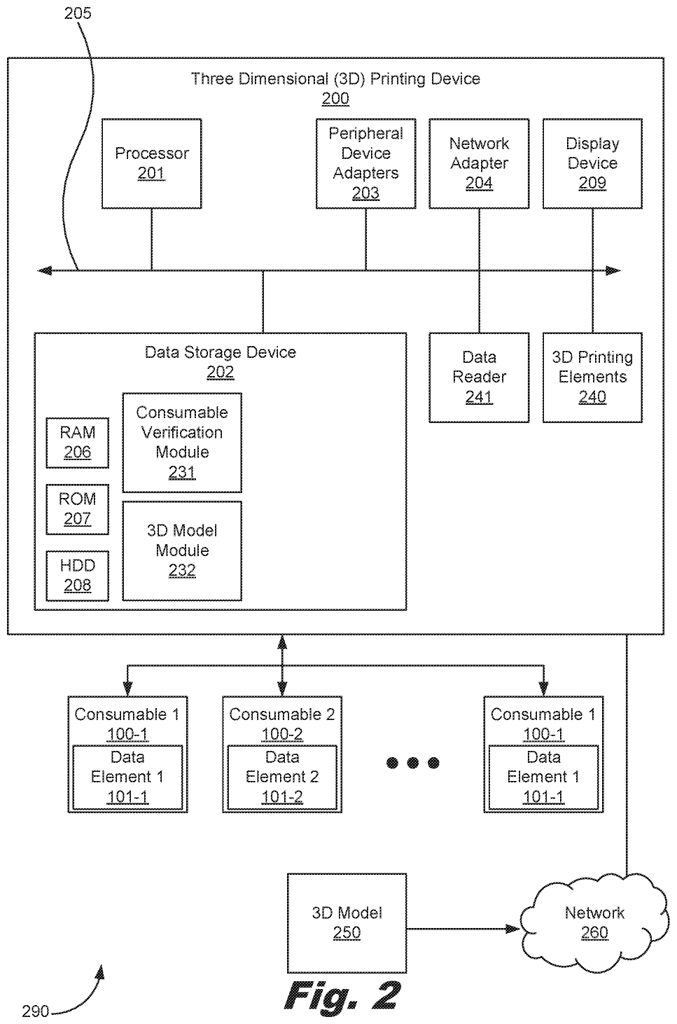

A data element (101) may be associated with the printing consumable (100). The data element (101) defines an assigned association between the printing consumable (100) and a printing capability. The printing capability may be any function executable by a 3D printing device, technique executable by the 3D printing device, property of materials utilized by the 3D printing device, features printable by the 3D printing device, or combinations thereof. In the examples described herein, the capability may be any series of functions, techniques, properties of materials, or features used in the formation of a 3D object, or combinations thereof as described herein. In one example, the data element (101) associated with the printing consumable (100) defines what capability or combinations of capabilities are used in the formation of the 3D object. Further, in another example, requests to use a capability or combinations of capabilities of the 3D printing device or a capability or combinations of capabilities associated with the 3D printing device may be embedded or encoded within a 3D model used by the 3D printing device as input to create the 3D object. In still another example, an operator of the 3D printing device may decide to apply a capability or combinations of capabilities in the formation of the 3D object. In this example, the operator may apply a capability or combinations of capabilities in situations where the 3D model creators are unaware the capabilities exist within that 3D printing device. In yet another example, the data element (101) associated with the printing consumable (100), the 3D model used by the 3D printing device as input to create the 3D object, the operator, or combinations thereof may define what capabilities or combinations of capabilities are used in the formation of the 3D object. The printing consumable (100) will now be described in more detail in connection with FIG. 2.

FIG. 2 is a block diagram of a system (290) for protecting a three-dimensional (3D) printing capability, according to another example of the principles described herein. Portions of the system (290) may be implemented in an electronic device. Examples of electronic devices include servers, desktop computers, laptop computers, personal digital assistants (PDAs), mobile devices, smartphones, gaming systems, and tablets, among other electronic devices. For example, a 3D model of the to-be-printed 3D object may be imported through a network (260) to a 3D printing device (200) using such an electronic device. Further, the 3D printing device (200) may include hardware included in electronic devices as described herein.

The system (290) may be utilized in any data processing scenario including, stand-alone hardware, mobile applications, through a computing network, or combinations thereof. Further, the system (290) may be used in a computing network, a public cloud network, a private cloud network, a hybrid cloud network, other forms of networks, or combinations thereof. In one example, the methods provided by the system (290) are provided as a service over a network by, for example, a third party. In this example, the service may include, for example, the following: a Software as a Service (SaaS) hosting a number of applications; a Platform as a Service (PaaS) hosting a computing platform including, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the system (290) are executed by a local administrator.

To achieve its desired functionality, the 3D printing device (200) of the system (290) may include various hardware components. Among these hardware components may be a number of processors (201), a number of data storage devices (202), a number of peripheral device adapters (203), and a number of network adapters (204). These hardware components may be interconnected through the use of a number of busses and/or network connections. In one example, the processor (201), data storage device (202), peripheral device adapters (203), and network adapter (204) may be communicatively coupled via a bus (205).

The processor (201) may include the hardware architecture to retrieve executable code from the data storage device (202) and execute the executable code. The executable code may, when executed by the processor (201), cause the processor (201) to implement at least the functionality of receiving data representing a 3D model of a to-be-printed object, printing a 3D object based on the 3D model, identifying an assigned association between a printing consumable (100) and a printing capability, determining whether a printing consumable (100) is installed in the 3D printing device (200), regulating a provisioning of the printing consumable (100) based on a determination as to whether the printing capability is used in printing the 3D object, other functionality described here, and combinations thereof according to the methods of the present specification described herein. In the course of executing code, the processor (201) may receive input from and provide output to a number of the remaining hardware units.

The data storage device (202) may store data such as executable program code that is executed by the processor (201) or other processing device. As will be discussed, the data storage device (202) may specifically store computer code representing a number of applications that the processor (201) executes to implement at least the functionality described herein. The data storage device (202) may include various types of memory modules, including volatile and nonvolatile memory. For example, the data storage device (202) of the present example includes Random Access Memory (RAM) (206), Read Only Memory (ROM) (207), and Hard Disk Drive (HDD) memory (208). Many other types of memory may also be utilized, and the present specification contemplates the use of many varying type(s) of memory in the data storage device (202) as may suit a particular application of the principles described herein. In certain examples, different types of memory in the data storage device (202) may be used for different data storage needs. For example, in certain examples the processor (201) may boot from Read Only Memory (ROM) (207), maintain nonvolatile storage in the Hard Disk Drive (HDD) memory (208), and execute program code stored in Random Access Memory (RAM) (206). The data storage device (202) may include a computer readable medium, a computer readable storage medium, or a non-transitory computer readable medium, among others. For example, the data storage device (202) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters (203, 204) in the 3D printing device (200) of the system (290) enable the processor (201) to interface with various other hardware elements, external and internal to the 3D printing device (200). For example, the peripheral device adapters (203) may provide an interface to input/output devices, such as, for example, a display device (209), a mouse, or a keyboard. The peripheral device adapters (203) may also provide access to other external devices such as an external storage device, a number of network devices such as, for example, servers, switches, and routers, client devices, other types of computing devices, and combinations thereof.

The display device (209) may be provided to allow a user of the system (290) to interact with and implement the functionality of the system (290). The peripheral device adapters (203) may also create an interface between the processor (201) and the display device (209) or other media output devices. The network adapter (204) may provide an interface to other computing devices within, for example, a network (260), thereby enabling the transmission of data between the system (290) and other devices located within the network (260). The system (290) may, when executed by the processor (201), display the number of graphical user interfaces (GUIs) on the display device (209) associated with the executable program code representing the number of applications stored on the data storage device (202). The GUIs may include aspects of the executable code including user-interactive selections available to a user for printing a 3D object based on the 3D model.

The 3D printing device (200) may further include a number of 3D printing elements (240) used to form a 3D object based on the 3D model. The 3D printing elements may include a number of material printheads, moveable stages on which the 3D object is formed, curing systems, and ventilation systems, among other tools and elements used by a 3D printing device to form the 3D object. The 3D printing elements (240) may be integrated into the 3D printing device (200), or may include a separate, post-printing device or system separate from but associated with the 3D printing device (200).

The system (290) further includes a number of modules used in the implementation of the functionality of the system (290). The various modules within the system (290) include executable program code that may be executed separately. In this example, the various modules may be stored as separate computer program products. In another example, the various modules within the system (290) may be combined within a number of computer program products; each computer program product including a number of the modules.

The system (290) may include a consumable verification module (231) to, when executed by the processor (201), identify, verify, and authenticate a consumable associated with the 3D printing device (200). The consumable verification module (231) identifies the data elements (101-1, 101-2, 101-n, collectively referred to herein as (101)) associated with the printing consumable (100-1, 100-2, 100-n, collectively referred to herein as (100)). In one example, the consumable verification module (231) may also be executed to provide authorization for use of a printing capability during manufacturing in instances where the 3D model calls for a specific printing capability to be used in manufacturing the 3D object. In this example, the 3D model (250) may be restricted from being printed if the printing capability is not available.

In one example, the data elements (101) may include a computing device such as a near-field communication (NFC) device from which data may be read. In this example, the NFC device data elements (101) may use radio-frequency identification (RFID) technologies to allow both the supply of power and the communication of data from a passive electronic tag using radio waves. The data read from the NFC device data elements (101) in this example may include data regarding the printing capability, an association between a printing capability and data identifying the 3D model to be printed using the printing consumable (100), at least a portion of the data representing the 3D model (250) itself, data identifying a relationship between the printing consumable (100) and the 3D model (250), data identifying a relationship between the printing capability and the printing consumable (100), data identifying a relationship between the printing capability and the 3D model (250), authorization to use the printing capability and/or the printing consumable (100) to print a 3D object defined by the 3D model (250), an amount of the printing consumable (100), an availability of the printing consumable (100), other data that may be used in performing the functions described herein, or combinations thereof. This data may be read from the NFC device data elements (101) or other device data elements (101) using a data reader (241) and the consumable verification module (231) executed by the processor (201) of the 3D printing device (200). In this example, the data reader (241) may be any NFC compliant device as an initiator that employs electromagnetic induction between two loop antennas, one in the data reader (241) and one in the data elements (101) when NFC-enabled devices are within range, and actively generates an RF field that can power the data elements (101) as passive targets in order to provide data exchange. Further, in one example, the data element (101) may be embedded in the printing consumable (100), and may include a processing device and/or a data storage device or executing the printing capability based on data stored in the data storage device.

In one example, the data elements (101) may be writable and readable. For example, the data element (101) may limit the use of the printing consumable (100) by restricting the number of 3D models (FIG. 2, 250) that may be printed. In this example, the data element (101) may be written to indicating a decrease in the number of times the 3D model (FIG. 2, 250) may be printed. In one example, the data elements (101) may be write-once memory devices.

In another example, the data element (101) may include an identifier marked on the printing consumable (100). In this example, the identifier may be any imageable series of characters or a pattern placed on the printing consumable (100) or a container of the printing consumable (100). The series of characters or a pattern of characters may include, for example, a data matrix, a bar code, or a OR code, among other characters and patterns of characters. The data reader (241) in this example may be an optical detector or camera that may image the data element (101) and convey the image to the processor for identification using the executed consumable verification module (231). The identifier data element (101) of this example identifies the printing capability programmed in the 3D printing device (200) as memory and/or firmware stored in the data storage device (202). Further, like the NFC device data elements (101), the identifier data element (101) of this example may include data regarding the printing capability, an association between a printing capability and data identifying the 3D model to be printed using the printing consumable (100), at least a portion of the data representing the 3D model (250) itself, data identifying a relationship between the printing consumable (100) and the 3D model (250), data identifying a relationship between the printing capability and the printing consumable (100), data identifying a relationship between the printing capability and the 3D model (250) authorization to use the printing capability and/or the printing consumable (100) to print a 3D object defined by the 3D model (250), an amount of the printing consumable (100), an availability of the printing consumable (100), other data that may be used in performing the functions described herein, or combinations thereof.

In the examples of data elements (101) described herein, the data elements (101) may include a decryption key embedded within or associated with the printing consumable (100). The decryption key may be used to decrypt data providing access to the printing capability. The decryption key system used to secure the printing capability may utilize any key sharing system including any type of secret key sharing system. In one example, the decryption key of the data elements (101) may be at least a portion of any type of public, private, or symmetric key system, with the 3D printing device (200) having access to another portion of the decryption key. The decryption key of the data elements (101) may be used to decrypt information regarding the use of the printing capability or verifiable authorization code to use this capability. Further, in another example, portions of the decryption key may be embedded within or associated with a plurality of printing consumables (100). In this example, all of the plurality of printing consumables (100) are to be installed before the printing capability is made available. In this manner, the use of the printing capability may be secured based on whether the operator of the 3D printer (200) has possession of at least one of the printing consumables (100). This, in turn, maintains the protection of the printing capability as a trade secret or proprietary information as to the manufacturing of a 3D object defined by the 3D model (250) by ensuring that knowledge regarding use of a specific printing consumable (100) to form a 3D object is obtained only in authorized circumstances. Further, the systems and methods described herein allow for the association of a printing capability with a number of printing consumables (100) while allowing for other printing consumables (100) to not be associated with the printing capability or permissions to use the printing capability. Also, a number of printing consumables (100) may be used by the 3D printing device (200) freely without authorization and without being associated with a printing capability. Thus, the 3D printing capabilities may be protected through the printing consumables (100) while still allowing other printing consumables not being used to protect 3D printing capabilities to be used or consumed by the 3D printing device (200).

In another example, the instructions, code, or data for performing the capability may be stored in the data element (101). In this manner, the printing capability may be available to the 3D printing device (200) when it can read the data element (101). In another example the instructions, code, or data for performing the capability may be stored elsewhere, and a method to retrieve the instructions, code, or data may be stored in the data element (101). In this example, the data element may contain a web address from which the instructions, code, or data may be retrieved, or a key which may be used to sign a request to retrieve the instructions, code, or data where the signature serves as proof that it came from a 3D printing device (200) that includes the printing consumable (100).

In some examples, provisioning of the printing consumable (100) may not be limited to 3D models (250) that call of the use of the associated printing capability. For example, the operator of the 3D printing device (200) may use a “fine resolution” material to form a low-resolution model where a low-resolution material is called for by the 3D model. In this example, if an operator of the 3D printing device (200) ran out of a standard material, the operator may decide to complete a print job using the fine resolution material even though a fine resolution capability is not used or called for by the 3D model. In this example, the operator may be warned via, for example, a notification displayed on the display device a message such as, for example, “The installed consumable supports an additional capability, but that capability is not used for printing this model.” This will convey to the operator that there may be a less expensive version of the consumable, which does not support the additional capability, but may be used to produce a particular model that does not call for the printing capability. In one example, the ability of a user to substitute superior printing consumables (100) may be used as a marketing tool where a user is provided a free upgrade in the materials to advertise or encourage the user to use a new printing capability.

The system (290) may include a 3D model module (232). The 3D model module (232) may, when executed by the processor (201), instruct the 3D printing elements (240) to form the 3D object based on the 3D model (250) and consume the printing consumables (100).

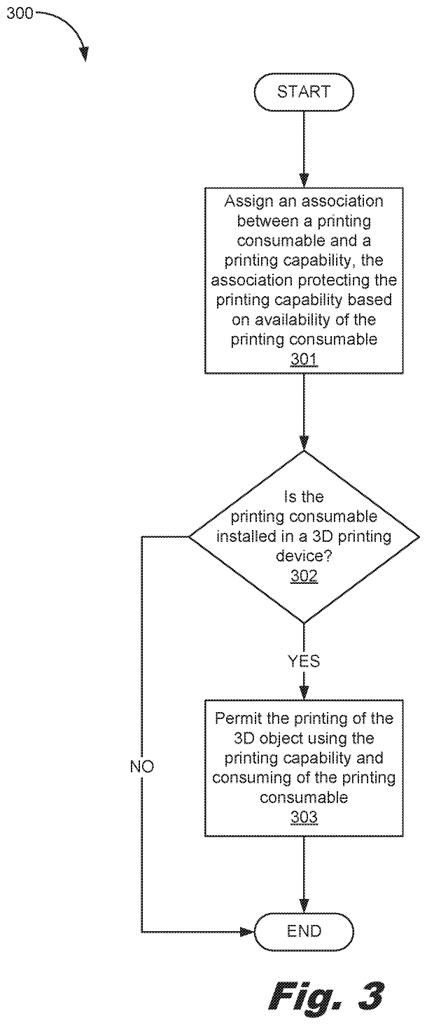

FIG. 3 is a flowchart showing a method (300) of protecting a printing capability via printing consumables (100), according to an example of the principles described herein. The method (300) may begin by assigning (block 301) an association between at least one printing consumable (100) and at least one printing capability. The association (block 301) protects the at least one printing capability based on availability of the at least one printing consumable (100), and prevents the use of the printing capability in the absence of the printing consumable (100). In other words, the 3D printing device (200) may be restricted from printing the 3D model (250) if the printing consumables (100) associated with the at least one printing capability are not supplied to an operator of the 3D printing device (200), or are not authorized through the use of, for example, an encryption/decryption key system.

The 3D printing device (200) may determine (block 302) whether the correct printing consumable (100) is installed in the 3D printing device (200) to allow for the execution of the printing capability in forming a 3D object. This determination (block 302) may be made by the processor (201) executing the consumable verification module (231), verifying authenticity of the printing consumable (100) and whether the valid authorization code is extracted from the printing consumable (100). Further, as part of this determination (block 302), the 3D printing device (200) may identify the existence of the printing consumable (100) within or attached to the 3D printing device (200), whether the 3D printing device (200) is authorized to utilize the printing consumable (100) to create the 3D object, whether the 3D model (250) calls for the use of the printing consumable (100), or combinations thereof.

In response to a determination that the printing consumable (100) is installed in the 3D printing device (200) to allow for the execution of the printing capability (block 320, determination YES), the 3D printing device (200) is permitted (block 330) to use the printing capability and consume of the printing consumable (100) in forming the 3D object based on the data defining the 3D model (250). In doing so, the processor (200) may execute the 3D model module (232) which instructs the 3D printing elements (240) to form the 3D object in addition to the use of the printing capability and consuming of the printing consumable (100). However, in response to a determination that the printing consumable (100) is not installed in the 3D printing device (200) to allow for the execution of the printing capability (block 320, determination NO), the 3D printing device (200) is restricted from using the printing capability and consuming the printing consumable (100) in forming the 3D object based on the data defining the 3D model (250), and the method terminates without printing the 3D object. In one example, the 3D model (250) may still be produced without using the printing capability called for by the 3D model (250). In yet another example, the operator may be prompted to insert the printing consumable (100), and the print job may be temporary suspended awaiting for the correct printing consumable (100) to be installed in the 3D printing device (200).

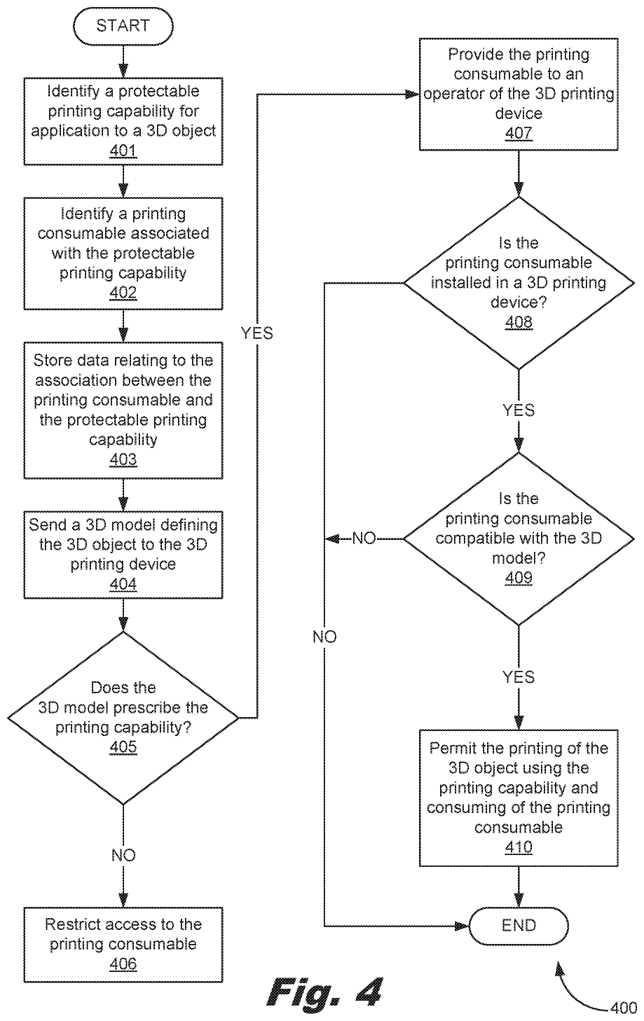

FIG. 4 is a flowchart showing a method (400) of protecting a printing capability via printing consumables (100), according to another example of the principles described herein. The method (400) of FIG. 4 may begin by assigning (block 301) an association between at least one printing consumable (100) and at least one printing capability as described in connection with FIG. 3. This may include identifying (block 401) the protectable printing capability for application to the 3D object. As described herein, an entity or individual may desire to protect manufacturing techniques, processes, materials, and know-how while still allowing for the manufacturing of their 3D objects using, for example, a 3D printing device (200). In another example, an entity or individual may desire to sell the manufacturing techniques or extra functionalities at a cost, and retain full control and accountability over the use of this functionality. In order to do so, the proprietary 3D manufacturing techniques, processes, materials, and know-how may be identified and embodied as a printing capability. In one example, know-how may be included as the 3D printing device (200) functionality where the printing consumable (100) delivers an authorization code for use of this functionality.

The method may also include identifying (block 402) at least one printing consumable (100) associated with the protectable printing capability. Any number of printing consumables (100) may be associated with the printing capability based on, for example, the type and intricacies of the printing capability. For example, one printing capability may be a polishing process in which a polishing device coupled to or associated with the 3D printing device (200) may polish a printed object based on the 3D model (250). In this example, the polishing device and the polishing process serve as printing consumables. Further, if a polish chemical is used on connection with the polishing device, the polish chemical also serves as a printing consumable.

In one example, the method (400) may include storing (block 403) data relating to the association between the printing consumable (100) and the protectable printing capability. This data may identify the printing consumables (100) used to execute the printing capability, and may include instructions regarding the execution of the printing capability including, for example, the timing of the use of the printing consumables (100) within the manufacturing or 3D printing process, the duration of use of the printing consumables (100), the frequency of use of the printing consumables (100), other instructions regarding the execution of the printing capability, or combinations thereof. The data stored at block 403 may also include data regarding an encryption/decryption key system including, for example, a decryption key to decrypt data regarding the 3D model (250), an encryption key to encrypt data regarding the 3D model (250), the data elements (101) defining an assigned association between the printing consumable (100) and the printing capability, or combinations thereof.

The method (400) of FIG. 4 may also include sending (block 404) the 3D model (250) defining the 3D object to be printed to the 3D printing device (200). In one example, the 3D model (250) may be sent to the 3D printing device (200) using electronic data communications such as email between a computing device of a designer of the 3D model and an operator of the 3D printing device (200). The 3D model (250) defines the instructions used by the 3D printing device (200) to print a 3D object. The processor (200) may execute the 3D model module (232) and instruct the 3D printing elements (240) to form the 3D object based on the 3D model (250). In one example, the printing capability may also be sent to the 3D printing device (200) directly as an encrypted file or files to be decrypted by a decryption key within the data elements (101) associated with the printing consumables (100). In another example, the printing capability may also be sent to the 3D printing device (200) indirectly as a portion of the data stored with the data elements (101). In still another example, the printing capability may also be sent to the 3D printing device (200) directly as an encrypted portion of the 3D model (250) to be decrypted by a decryption key within the data elements (101) associated with the printing consumables (100). In yet another example, the data elements (101) of the printing consumables (100) may include encrypted data that defines a portion of the printing capability less than a total of the printing capability such that both the data sent to the 3D printing device (200) and the data encrypted in the data elements (101) is less than the whole of printing capability. This allows for greater security as both the 3D model (250) and the printing consumable (100) have to exist in order for the whole of the printing capability to be understood and realized.

The method (400) may also include regulating provisioning of the printing consumable (100) based on a determination (block 405) as to whether the printing capability is used in printing the 3D object. Regulation of the provisioning of the printing consumable (100) may include providing or not providing build materials, adhesives, or finishing stations to an operator of the 3D printing device (200). In response to a determination that the printing capability is used in printing the 3D object (block 405, determination YES), the printing consumable (100) may be provided (407) to an operator of the 3D printing device. In contrast, in response to a determination that the printing capability is not used in printing the 3D object (block 405, determination NO), access to the printing consumable (100) may be restricted by, for example, not sending the printing consumables (100) to the operator of the 3D printing device. In one example, the method may not include blocks 405 and 406. In this example, the 3D model (250) may be sent (block 404) to the 3D printing device (200), and the printing consumable (100) may be provided (407) to an operator of the 3D printing device.

The 3D printing device (200) may determine (block 408) whether the printing consumable (100) is installed in the 3D printing device (200) to allow for the execution of the printing capability in forming a 3D object as described herein in connection with block 302 of FIG. 3. This determination (block 408) may be made by the processor (201) executing the consumable verification module (231). Further, as part of this determination (block 408), the 3D printing device (200) may identify the existence of the printing consumable (100) within or attached to the 3D printing device (200), whether the 3D printing device (200) is authorized to utilize the printing consumable (100) to for the 3D object, whether the 3D model (250) calls for the use of the printing consumable (100), or combinations thereof.

In response to a determination that the printing consumable (100) is installed in the 3D printing device (200) to allow for the execution of the printing capability (block 408, determination YES), then the consumable verification module (231) executed by the processor (201) may determine whether the printing consumable (100) is compatible with the 3D model (250) of the 3D object (block 409). However, in response to a determination that the printing consumable (100) is not installed in the 3D printing device (200) to allow for the execution of the printing capability (block 408, determination NO), the 3D printing device (200) is restricted from using the printing capability and consuming the printing consumable (100) in forming the 3D object based on the data defining the 3D model (250), and the method terminates without printing the 3D object. In response to a determination that the printing consumable (100) is compatible with the 3D model (250) of the 3D object (block 409, determination YES), printing of the 3D object may be allowed using the printing consumable (100). In response to a determination that the printing consumable (100) is not compatible with the 3D model (250) of the 3D object (block 409, determination NO), printing of the 3D object using the printing consumable (100) may be restricted, and the method (400) terminates without printing the 3D object.

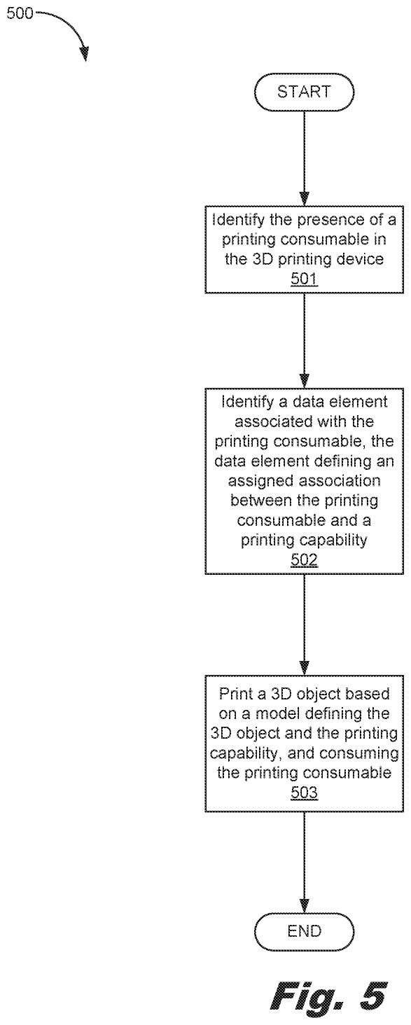

FIG. 5 is a flowchart showing a method (500) of protecting a printing capability via printing consumables (100), according to still another example of the principles described herein. The method (500) of FIG. 5 includes a number of processes associated with the actions taken by the 3D printing device (200), and may include, with the processor (201) executing the consumable verification module (231), identifying (block 501) the presence of a printing consumable (100) in a 3D printing device (200). The consumable verification module (231) may also be executed by the processor (201) to identify (block 502) a data element (101) associated with the printing consumable (100). The data element (101) defines an assigned association between the printing consumable (100) and a printing capability. The 3D printing device (200) may then print (block 503) a 3D object based on the 3D model (250) defining the 3D object and the printing capability, and consuming the printing consumable (100).

In one example, the method (500) may also include determining whether the printing consumable (100) is compatible with a 3D model (250) of the 3D object to be printed by the 3D printing device (200) as similarly described herein in connection with FIGS. 3 and 4. In response to a determination that the printing consumable (100) is compatible with the 3D model (250) of the 3D object, the 3D printing device may print the 3D object consuming the printing consumable (100). However, in response to a determination that the printing consumable (100) is not compatible with the 3D model (250) of the 3D object, printing of the 3D object using the printing consumable (100) may be restricted.

Further, in one example, the method (500) may also include assigning an association between the printing consumable (100) and a printing capability where the association protects the printing capability based on availability of the printing consumable (100) as described herein in connection with FIGS. 3 and 4. It may be determined whether the printing consumable (100) is installed in a 3D printing device (200) to allow for the execution of the printing capability in forming a 3D object. In response to a determination that the printing consumable (100) is installed in the 3D printing device (200) to allow for the execution of the printing capability, the printing device (200) may print the 3D object using the printing capability and consuming the printing consumable (100).

Further, in the examples described herein, the printing consumables (100) may be restricted (block 406) with respect to the operator of the 3D printing device (200). Restriction may take the form of regulating the provisioning of the printing consumable (100), and may include providing or not providing build materials, adhesives, or finishing stations to the operator of the 3D printing device (200). In an example, the restriction (406) prevents the operator of the 3D printing device (200) from using the printing consumable (100). For example the printing consumable (100) may be a proprietary consumable that may be used for a specific printing capability. In another example, the restriction may include provisioning of a warning to the operator of the 3D printing device (200) that using the printing consumable (100) may be undesirable. For example, where a printing consumable (100) is more expensive because it supports a printing capability while the 3D model (250) to be printed does not call for the printing capability.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor (201) of the 3D printing device (200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

In the examples described herein, the printing capabilities may be optional, and may be purchased for a fee ala carte or as a group of a number of printing capabilities. These printing capabilities may be numbered among the 3D printing elements (240) internal to the 3D printing device (200) integrated into the 3D printing device (200), or may be separate devices.

The specification and figures describe a system for protecting a three-dimensional (3D) printing capability may include a printing consumable, and a data element associated with the printing consumable, the data element defining an assigned association between the printing consumable and a printing capability. Also, a method of protecting a printing capability via consumables may include assigning an association between a printing consumable and a printing capability, the association protecting the printing capability based on availability of the printing consumable, determining whether the printing consumable is installed in a 3D printing device to allow for the execution of the printing capability in forming a 3D object, and in response to a determination that the printing consumable is installed in the 3D printing device to allow for the execution of the printing capability, permitting the printing of the 3D object using the printing capability and consuming of the printing consumable.

The systems and methods described herein allows printing capabilities to be traded by trading physical printing consumables. Further, these systems and methods protect proprietary printing capabilities by using physical objects, but without adding very much overhead since the printing consumables are to be procured and transported to an operator before printing anyway. Still further, the systems and methods separate printing capabilities from the 3D models that define or provide instructions to printing the 3D objects. In this manner, both the 3D models and the printing capabilities may each be controlled separately. A single 3D model may be printed to form a 3D object in different ways using different printing capabilities, and a single printing capability may be used to print many different 3D models. Yet further, the systems and methods described herein are easy to explain to operators of 3D printing devices since the operators associate some attributes with printing consumables. For example, the operators may already know “Add a conductive ink consumable for electrical components”, and now we extend that to “Add fine feature conductive ink for small electrical components. The chemical composition of the ink may be identical, but fine features may use particular print profiles which take time to develop, and that valuable printing capability may be protected and monetized using information embedded in containers of the fine feature conductive ink without the operator knowing about this proprietary printing capability.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of protecting a printing capability via consumables, comprising:
assigning an association between a printing consumable and a printing capability, the association protecting the printing capability based on availability of the printing consumable;
determining whether the printing consumable is installed in a 3D printing device to allow for the execution of the printing capability in forming a 3D object; and
in response to a determination that the printing consumable is installed in the 3D printing device to allow for the execution of the printing capability, permitting the printing of the 3D object using the printing capability and consuming of the printing consumable.

2. The method of claim 1, comprising regulating provisioning of the printing consumable based on a determination as to whether the printing capability is used to print the 3D object.

3. The method of claim 2, comprising:
in response to a determination that the printing capability is used to print the 3D object, providing the corresponding printing consumable to an operator of the 3D printing device, and
in response to a determination that the printing capability is not used to print the 3D object, restricting access to the printing consumable.

4. The method of claim 1, wherein assigning the association between the printing consumable and the printing capability comprises:
identifying the protectable printing capability for manufacturing of the 3D object;
identifying the printing consumable associated with the protectable printing capability; and
storing data relating to the association between the printing consumable and the protectable printing capability.

5. The method of claim 1, comprising electronically sending permission to use the printing capability to the 3D printing device.

6. The method of claim 1, comprising electronically sending a model defining the 3D object to the 3D printing device, the model including instructions to use the printing capability.

7. The method of claim 1, comprising:
determining whether the printing consumable authorizes the use of the printing capability used to manufacture the 3D object;
in response to a determination that the printing consumable authorizes the use of the printing capability, allowing printing of the 3D object using the printing consumable;
in response to a determination that the printing consumable does not authorize the use of the printing capability, restricting printing of the 3D object using the printing capability.

8. A computer program product for protecting a printing capability, the computer program product comprising:
a computer readable storage medium comprising computer usable program code embodied therewith, the computer usable program code to, when executed by a processor:
identify the presence of a printing consumable in a 3D printing device;
identify a data element associated with the printing consumable, the data element defining an assigned association between the printing consumable and a printing capability;
print a 3D object based on a model defining the 3D object and the printing capability, and consuming the printing consumable.

9. The computer program product of claim 8, comprising the computer usable program code to, when executed by the processor:
determine whether the printing consumable authorizes the use of the printing capability;
in response to a determination that the printing consumable authorizes the use of the printing capability, print the 3D object consuming the printing consumable;
in response to a determination that the printing consumable does not authorize the use of the printing capability, restrict printing of the 3D object using the printing consumable.

10. The computer program product of claim 8, comprising the computer usable program code to, when executed by the processor:
assign an association between a printing consumable and a printing capability, the association protecting the printing capability based on availability of the printing consumable;
determining whether the printing consumable is installed in a 3D printing device to allow for the execution of the printing capability in forming a 3D object; and
in response to a determination that the printing consumable is installed in the 3D printing device to allow for the execution of the printing capability, printing the 3D object using the printing capability and consuming the printing consumable.

11. A system for protecting a printing capability, comprising:
a printing consumable; and
a data element associated with the printing consumable, the data element defining an assigned association between the printing consumable and a printing capability.

12. The system of claim 11, wherein the data element comprises a decryption key embedded within the printing consumable, the decryption key decrypting data providing access to the printing capability.

13. The system of claim 11, wherein the data element comprises a computing device embedded in the printing consumable, the computing device comprising a processor and a data storage device, the processor executing the printing capability based on data stored in the data storage device.

14. The system of claim 11, wherein the data element comprises an identifier marked on the printing consumable, the identifier being verifiable by a 3D printing device, wherein the identifier enables the printing capability programmed in firmware of a 3D printing device.

15. The system of claim 11, wherein the printing capability comprises a number of 3D printing techniques executable by a 3D printing device.
